(19) United States
(12) Patent Application Publication
(10) Pub. No.: US 2013/0043188 A1
(43) Pub. Date: Feb. 21, 2013

(54) CONTROL OF IMMERSED MEMBRANE SYSTEM CONSIDERING ENERGY COST FLUCTUATIONS

(71) Applicant: Michael David THEODOULOU, Milton (CA)

(72) Inventor: Michael David THEODOULOU, Milton (CA)

(21) Appl. No.: 13/212,310

(22) Filed: Aug. 18, 2011

(51) Int. Cl. B01D 65/00; C02F 1/44; B01D 61/00

(52) U.S. Cl. 210/650; 210/142

(57) ABSTRACT

An immersed membrane filtration system is operated in view of an electricity pricing programs in which the price of electricity varies over time. Examples of such programs include time of use pricing, critical peak pricing and critical peak rebate programs. Alternatively, the filtration system may be operated, for example as part of a smart grid, in view of requests or demands by an electrical utility for time limited reductions in energy use. During a high energy cost period of time, one or more membrane units are shut down. Preferably, aeration of the still operating membrane units is not increased. The flux of the still operating trains may be increased towards a pre-determined maximum permitted flux, or towards a maximum flux that is calculated in view of operational parameters such as water temperature or viscosity. Optionally, during a low energy cost period of time, one or more additional membrane units may be turned on. Optionally, the transfer of water from an equalization tank may also be controlled in view of the energy pricing program.

### FIELD

This specification relates to methods and apparatus for controlling a water treatment system using immersed membranes, for example as in a membrane bioreactor (MBR) used to treat municipal wastewater.

### BACKGROUND

The following description of background information is not an admission that anything described in this section is common knowledge or citable as prior art.

In an immersed membrane water treatment system, a plurality of membranes are immersed in an open tank containing the water to be filtered. The membranes may be arranged in modules or elements which comprise the membranes and frames or potting heads headers attached to the membranes. The modules may be connected together into larger assemblies, called racks or cassettes, before they are immersed in a tank. Multiple cassettes may be connected together into even larger assemblies called trains or banks. A transmembrane pressure in applied across the membrane walls by way of suction which causes filtered water to permeate through the membrane walls. A set of trains of banks in operation collectively produce a required total flow of permeate. Solids are rejected by the membranes and remain in the water in the tank until the water is removed from the tank for recycle or further treatment.

Membrane fouling is a common operational problem encountered in immersed membrane treatment systems. Membrane fouling occurs when membranes pores are obstructed resulting in the loss of membrane permeability. Membrane fouling is influenced by diverse operational parameters such as influent wastewater temperature and permeate flux. A resistance in series method has been used for membrane fouling quantification and to identify the main fouling mechanism (i.e. pore blocking or cake filtration) produced by a given set of operational conditions. There are several operational alternatives available to inhibit or counter fouling. For example, aeration, relaxation (a temporary stop in permeation while aerating) and backwash are designed to mechanically remove foulants deposited on the membrane surface or loosely inserted into the membrane pores. On the other hand, maintenance and recovery chemical cleaning are meant to chemically remove foulants deeply adsorbed into the membrane pores and biofilms strongly attached to the membrane surface. Despite these various methods, the membranes still experience long term fouling that decreases their permeability to an unacceptable level over a period of years. The membranes may also fatigue or harden over a period of years. Accordingly, the membranes have a useful life after which time they must be replaced.

In aeration, air bubbles are introduced to the tank through aerators which may be mounted below or within the membrane modules and connected by conduits to an air blower. The air bubbles rise to the surface of the membrane tank and create an air lift which moves water in the tank through the membrane module. When the rate of air flow is within an effective range, the rising bubbles and mixed liquor also agitate the membranes to inhibit solids in the mixed liquor from fouling the membrane pores. The bubbles can be supplied continuously, cyclically (e.g. 10 seconds on, 10 seconds off) or intermittently (e.g. 60 seconds every 30 minutes). In an aeration system as described in U.S. Pat. No. 6,550,747, cyclic aeration is provided through a set of controlled valves. In another aeration system as described in International Publication WO 2011/028341 aeration is provided from a pulsing aerator, the frequency of the pulses depending on the applied flow rate of air to the pulsing aerator. The electrical energy required to provide aeration is a significant contributor to the overall energy consumption of an immersed membrane system.

A membrane bioreactor (MBR) combines membrane technology and activated sludge biodegradation processes to treat wastewater. Sample MBRs and their operation are described for example in International Publication No. WO 2005/039742 A1. In municipal wastewater treatment systems in particular, the influent flows can be highly variable. There may be a daily variation according to which the rate of flow peaks in the morning, perhaps around 7 am, and in the evening, perhaps around 7 pm. In between these peak periods, there is significantly less flow. There may also be seasonal variations in the size of the peaks. Some equalization of the feed flow is generally provided by the system designer. In some installations, equalization may be provided upstream of the MBR by a separate equalization tank. In other installations, equalization is provided in process or membrane tanks of the MBR.

Despite the presence of equalization, an MBR must be designed to accept some variability over time in the amount of permeate flux required of the membranes. The number or membrane units in the MBR is chosen such that the MBR can handle the maximum expected permeate flow required in a year with all membrane units operating at their maximum permitted flux. Accordingly, at most times the membranes in the MBR are operating at less than theft maximum flux. However, the useful life of a membrane tends to decrease faster when the membrane is operated at a higher flux. Operating at less than maximum flux between peak flow periods extends membrane life.

In a simple design and operational strategy, the membrane aeration regime is chosen to handle the maximum expected permeate flux based on standard designs, pilot data or experience during commissioning of the plant. In many cases, the aeration regime is not adjusted after the plant is commissioned, or adjusted only infrequently. However, when the membranes are operated at a reduced flux they tend to foul less rapidly. This creates the possibility of making temporary operational changes to use less energy during periods of time when less than the maximum permitted flux is required.

In one operating strategy, the flux through a membrane train is compared to an Average Daily Flux (ADF). When flux is above the ADF, a higher level of aeration is used such as a 10 seconds on-10 seconds off (10/10) cyclic aeration regime. When flux is below the ADF, a lower level of aeration is used such as a 10 seconds on-30 seconds off (10/30) cyclic aeration regime. In another example of a control process described in US Publication No. 2007/0039888, if a membrane resistance value exceeds an upper set-point, then a cyclic aeration system switches to a 10/10 aeration regime. If the resistance value drops below a lower set-point, then the cyclic aeration system switches to a 10/30 aeration regime. If the resistance value remains below the lower set-point, then a train may be shut down and the flux increased in the still operating trains to compensate. This further reduces the energy consumption of the plant because the shut down train does not require aeration. However, an increase in flux is required in the still operating trains. If the control system detects a rise in the resistance of the operating train over the upper set-point, then the previously shut down train is restarted. If resistance persists over the upper set-point, then the cyclic aeration system switches back to the 10/10 aeration regime.

### Introduction

Many electrical utilities have adopted, or may adopt in future, pricing programs in which the price of electricity varies over time. Examples of such programs include time of use pricing, critical peak pricing and critical peak rebate programs. In other examples, the customer agrees to place a major appliance, typically an air conditioner, under the control of an electrical utility either for the good of the electrical system or to receive a rebate or price discount. A period of time during which consuming electricity causes, or is likely to cause, higher energy costs under a pricing program in effect, relative to consuming electricity at another time, will be referred to as a high energy cost period. A period of time during which consuming energy causes, or is likely to cause, lower energy costs under a pricing program, relative to consuming electricity at another time, will be referred to as a low energy cost period.

In a process and apparatus described herein, a membrane filtration system such as an MBR is operated considering higher or lower energy cost periods. During a high energy cost period, one or more membrane units such as a train are shut off, preferably without significantly changing the aeration regime of the still operating membrane units. The flux in the operating units may be pre-calculated or measured to determine if the flux can be, or is, below a selected maximum flux as a condition for the units being shut down or staying in shut down during the high energy cost period. The number of membrane units to shut down may be chosen such that units that remain in operation are as close as possible to, but do not exceed, the maximum flux. By maximizing the operating membrane flux during high energy demand periods, the number of membranes operating and thus the energy required to provide aeration may be reduced. Optionally, during a low energy cost period one or more additional membrane units may be turned on to provide a recovery period. During the recovery period, fluxes are reduced to help reduce the shortening of membrane service life.

The selected maximum flux may be a single pre-determined value, or a value that varies considering one or more variables related to the operation of the system or a possible consequence in electricity pricing. Operational variables may include, for example, water temperature, water viscosity, season, or an existing aeration regime. Variables that may indicate a possible consequence in electricity pricing may include, for example, outdoor air temperature, predicted outdoor air temperature, day of the week, or notices from an electricity supplier.

To determine when to make operational changes, a computing device in a plant operating system may have data relating to pre-stated pricing intervals entered into it, as well as a clock and calendar. Alternatively or additionally, the computing device may have access to sensors or communications links to gain information, such as an actual or predicted outdoor air temperature, that can be used to predict a high energy cost period. Further alternatively, the computing device may be adapted to receive communications from an electricity supplier to predict or recognize high energy cost periods, or to register a request or demand from the electricity supplier. The computing device may instruct one or more controllers to decrease the number of membrane trains operating during at least part of a high energy cost period. Alternatively, the computing device may increase an allowable operating flux or resistance during a high energy cost period, which may result in a pre-existing control strategy causing a membrane train to shut down.

Optionally, the plant permeate rate, and the transfer of water from an equalization tank to the filtration system if necessary, may also be controlled in view of the energy pricing model. In particular, the plant permeate rate may be decreased while a membrane train is shut off during a high energy cost period to reduce the flux required from the operating trains. To account for any corresponding build up of water in the plant, the plant permeate rate may be increased before the high energy cost period.

In the methods described above, energy usage is reduced for a period of time, but there may also be a decrease in the service life of the membrane units due to operating the membrane units more frequently at higher flux. However, the savings in energy cost may justify the decrease in service life. In particular, as the cost consequence of operating on only a small set of critical peak periods increases, it becomes more likely that any decrease in membrane service life will be justified by energy cost savings. Further, since a wastewater treatment plant may be responsible for a significant amount of the load on a grid, moving consumption away from peak periods may provide benefits to an electrical utility or society beyond any pricing benefits that flow to the pant operator.

### BRIEF DESCRIPTION OF THE FIGURES

FIG. 1 is a schematic representation of control system for an immersed membrane treatment system.

FIG. 2 is a schematic flow chart of a control process.

### DETAILED DESCRIPTION

While the electrical grid can be viewed in one sense as a large regional or national system, an electrical utility company or other electricity supplier is typically concerned with only a section of this larger grid. In the discussion below, the grid will refer to a section of the electrical grid that provides electricity to an immersed membrane filtration plant, and that is of concern for an electricity supplier that charges for the electricity consumed by the plant.

Under a variable rate electricity pricing scheme, the price charged for electricity may be higher when demand on the grid is high or tends to be high. In some cases, this takes the form of time of use pricing in which the price of electricity varies in a pre-determined manner over time. The variation may be by one or more of time of day, season, and day of the week. For example, under one time of use program, electricity costs the most from 11 am to 5 pm during weekdays in the summer and during two periods, from 7 am to 11 am and from 5 pm to 7 pm, on weekdays in the winter. Electricity costs the least under this program on weekends and holidays and between 7 pm and 7 am on weekdays. In this and other examples, the very highest rates may be charged on summer afternoons when air conditioning loads may raise demand on the grid to near, or even over, the capacity of the grid. The highest rates may be, for example, twice the lowest rates.

Under a critical peak pricing program, an exceptionally high cost is charged for electricity used on any one of a set of critical peak periods. A critical peak period is a period during which electrical use in an area is so high that there may be a risk of brown out or overload, or the electrical utility must purchase electricity from another utility. The management of critical peak periods is extremely important to the utility because, although there may only be ten or less critical peak periods in a year, those periods determine the required total generating capacity of the grid and its failure rate. In one example of a critical peak pricing program, an electricity supplier forecasts loads on its grid and sends a notification to customers, for example by telephone, e-mail or text message, at 3 p.m. if the following day will be declared a critical peak period. Under a critical peak rebate pricing model, customers are notified when a critical peak period is or will be declared. Customers then receive a rebate if they reduce their energy usage relative to a personalized forecast of their use during the critical peak period in response to the notice. Because of the importance of peak periods, the cost of electricity may be tripled compared to the previous highest rate during the critical peak period.

In other examples of pricing programs, an electricity supplier may offer a discount or rebate in exchange for the ability to request or force a customer to limit their use of electricity during periods of high load on the grid. The control may be a real time control in which the utility can send a signal to a controller on an appliance owned by the customer to directly cause the appliance to reduce its output. Alternatively, the control may be pre-determined. For example, a customer may receive an annual rebate if they agree to install a controller that automatically reduces the output of an air conditioner while the outdoor air temperature exceeds a threshold. Under these programs, the customer may receive a pricing benefit in that their electricity use will tend to be reduced while the cost of electricity is high. However, the customer may also receive a discount or rebate simply for subscribing to the program whether or not, for example, the electricity supplier ever takes advantage of its ability to control the customer's appliance. Accordingly, a high energy cost period may include a period of time that an electricity supplier is concerned about whether or not a specific rate is applied to that period of time.

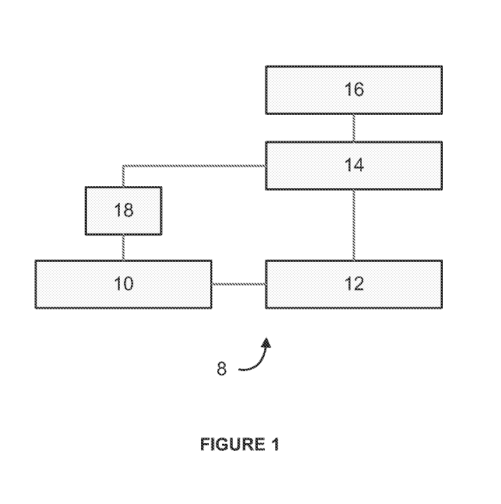

Referring to FIG. 1, a system 8 includes an immersed membrane water treatment system 10 which is connected to a computing device 14. The computing device 14 may be any device, for example a programmable logic controller or a general purpose computer, that is capable of accessing data, performing computations and outputting a result. The computing device 14 may access data from a self contained data storage medium or clock, through a communications device, through an operator interface 16, or by receiving a signal from one or more input devices 12, or through a combination of one or more of these means. The computing device 14 may communicate with an external source of controls or information such as a weather forecast provider or an electrical supplier.

The input devices 12 can include sensors providing signals corresponding to one or more of permeate flux, water temperature, sludge filterability, membrane resistance, water viscosity and outdoor air temperature. Membrane resistance measurements or sludge filterability measurements can be made, for example, according to the procedures described in US Publication No. 2007/0039888. Membrane resistance measurements can include one or more of resistance after backwash, change in resistance after backwash and cake filtration resistance.

After considering the information from the input devices 12, the computer 14, after running its own programs or as instructed by an operator through the interface 16, instructs process controllers 18 to operate the water treatment system 10. In particular, the process controllers 18 may control the production of permeate from membrane units in the water treatment system 10 and an aeration regime applied to the membrane units. Control of the aeration regime may include one or more of, changing an aeration rate during continuous aeration or during air on times in cyclic aeration, changing the air on and air off times in a cyclic aeration regime, and changing the air flow rate delivered to pulsing aerators. Control of permeate production may include opening or closing valves connecting membrane units to permeate collection pumps and adjusting the suction provided by the permeate collection pumps.

Many small membrane modules are typically grouped together into larger assemblies called cassettes or racks, and the racks may be grouped together into even larger assemblies called trains or banks. Individual aerators are similarly grouped together into larger units. It is typically not possible for a process controller 18 to isolate a particular module from a permeate withdrawal system or an aeration system since controlled permeate and air valves are provided only at the cassette or rack level or, more commonly, at the bank or train level. In the following discussion, a membrane unit will refer to a set of membrane modules for which the aeration and permeation of the set can be determined by one or more process controllers 18.

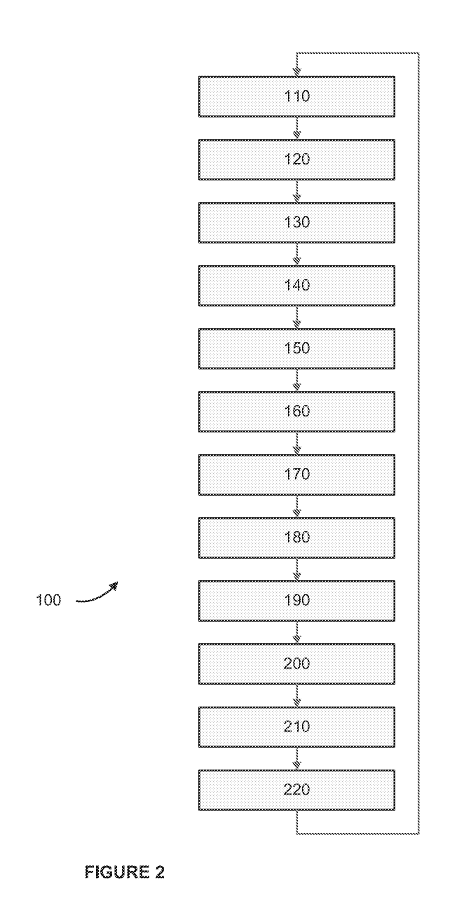

Referring to FIG. 2, a control process 100 repeats a loop having various steps. Some of these steps are optional or may be performed in a different order. The steps will be introduced in this paragraph, and some of the steps may also be described in greater detail below. At step 110, the computing device 14 predicts the onset of the next high energy cost period. At step 120, the computing device 14 instructs the controllers 18 to increase the plant permeate production rate in advance of the next high energy cost period, draining down any tanks responsible for equalization. At step 130, the computing device detects the start of a high energy cost period and determines a number of membrane units currently operating (N). At step 140, the computing device 14 determines a maximum operating condition, for example a maximum flux. At step 150, the computing device 14 instructs the controllers 18 to reduce the plant permeate production rate. At step 160, the computing device 14 determines the effect of operating with less (N-X) membrane units. At step 170, the computing device 14 instructs the controllers 18 to shut down one or more (X) membrane units. At step 180, the computing device 14 monitors the operation of the system. At step 190, the computing device 14 detects the end of the high energy cost period. At step 200, the computing device 14 instructs the controllers 18 to restart a number of membrane units (X) that were shut down in step 170. At step 210, the plant permeate production rate is restored to an average seasonal rate, or the rate similar to the rate that was used before step 120. At step 220, one or more additional membrane units are started to allow for operation at lower flux for a period of time.

Steps 110, 130 and 140 involve predicting or detecting high energy cost periods. The computing device 14 is adapted, for example by programming or communication with the operator interface 16, an outside party or one or more input devices 12, to determine when the system 8 is, or will be, operating in a high energy cost period. Detecting the start or end of a high energy cost period as in steps 130 and 190 can include some degree of detection in advance of the event, for example to provide time for the actions required to stop permeation through a membrane unit before a high energy cost period. Predicting the onset of a high energy cost period in step 110 is optional and provides an earlier prediction, for example on the order of several hours to a few days, if more time is required to prepare for a high energy cost period.

Specific acts required to detect a high energy cost period may vary depending on the electricity pricing program in effect. For example, in an area where time of use pricing is in effect, a high energy cost period set by an electricity utility may be initially entered through the interface 16 or otherwise loaded into data storage within the computing device 14. The computing device 14 determines when the system 8 is operating in, or near, the high energy cost period by comparing the high energy cost periods pre-determined by the electricity supplier to a clock or calendar or both.

In an area where pricing is related to critical peak periods, the computing device 14 may receive a notice from an electricity supplier that a present or future day or other period has been or will be declared a critical peak period. The notice may be input through the operator interface 16 or by direct communication between the computing device and the electricity supplier. Alternatively, the computing device 14 may be programmed to perceive and react to conditions that are likely to create critical peak periods. For example, in an area where critical peak periods are typically caused by unusually high air conditioning loads, the computer 14 may be programmed to assume that a high energy cost period exists whenever the outdoor air temperature is, or is predicted to be, over a threshold value, for example 27 degrees Celcius. Outdoor air temperature can be determined by one of the sensors 12, or by a signal received from a service providing an average current or predicted temperature over a geographical area generally consistent with an area served by the grid. Optionally, a critical peak period may be assumed only when an actual or forecasted high outdoor air temperature coincides with a non-holiday weekday.

The computing device 14 may also be adapted to receive and react to a request from an electricity supplier to reduce energy consumption. The request, which may be mandatory or optional, may be given to the computing device 14 through the operator interface 16 or by direct communication with the electricity supplier. Optionally, the computing device 14 may determine whether it is possible to comply with the request and send a return communication to the electricity supplier or to the operator interface 16 indicating whether the system is capable of reducing its energy consumption without exceeding operational limits, and if so by how much.

In step 140, the computing device 14 determines a maximum operating condition. The maximum operating condition may be a pre-determined condition that has been put into data storage in the computing device 14. For example, a maximum flux that applies at all times or until changed may have been programmed into the computing device 14 or entered through the operator interface 16. Optionally, the computing device 14 may be adapted, for example by programming or communication with the interface 16 or one or more of the input sensors 12, to determine a maximum flux that will apply during a particular high energy cost period. For example, as discussed in US Publication No. 2007/0039888, sludge filterability may be measured directly, and a more filterable sludge would indicate that maximum flux might be increased. Another particularly important factor effecting fouling is water viscosity. Water viscosity decreases with an increase in water temperate and with a decrease in suspended solids concentration. The viscosity of the water reaching the membranes can be measured directly, or approximated based on a water temperature reading or water temperature and solids concentration readings. Further, in warm seasons the temperature of the water tends to be high and solids concentrations tends to be low due to increased biological activity. Accordingly, any one or more of low viscosity, high water temperature, low solids concentration or a date within a historically warm season may be used to indicate a higher maximum flux and the absence of those conditions may indicate the need for a reduced maximum flux.

The prevailing aeration regime may also be considered in determining maximum flux. Switching to an aeration regime that consumes more energy is unlikely to be offset by the energy savings involved in shutting down a membrane unit. Accordingly, if an energy reduced aeration regime was already in effect before the start of the high energy cost period, the computing device 14 will determine a maximum flux consistent with the use of the energy reduced aeration regime. Optionally, the method 100 might include a step of considering a change to an aeration regime that consumes more energy to determine whether the in increased energy consumption could be offset by allowing even more membrane units to be shut down.

At step 160, the computing device 14 determines the effect of operating with less trains. The computing device 14 may first estimate a peak plant permeate flow that would be required during the high energy cost period and determine a number (N) of membrane units that were in operation before the start of a high energy cost period. The computing device 14 then calculates the flux that would be required of membrane units still in operation if X membrane units where shut down, stepping through a series of whole numbers for X, at least until the flux in the membrane units in operation would exceed the maximum flux.

At step 170, the computing device 14 instructs the process controllers 18 to shut down X membrane units, where X is the largest number of units predicted to avoid having the membrane units in operation exceed the maximum flux. Despite the increase in flux, aeration in the operating membrane units is not materially increased. At step 180, the computing device 14 monitors the operation of the system, for example checking to see that the maximum flux is not exceeded. If the maximum flux is exceeded, the computing device 14 may take an action, such as sending an alert through the operator interface 16 or re-starting a membrane unit.

At step 200, X membrane units are re-started at or near the end of the high energy cost period. The particular membrane units that had been shut down may be re-started, or other membrane units that were on standby before the high energy cost period, if any, may be re-started. In there were any membrane units on standby before the high energy cost period, then both the membrane units that had been shut down during the high energy cost period and the standby units may be restarted, and a membrane unit that was operating during the high energy cost period may be shut down.

During step 220, which is optional, the water treatment system 10 is operated with additional membrane units in operation during a low energy cost period, or at least outside of the high energy cost period. The reference to additional membrane units does not refer to any particular membrane units, but instead indicates that more membrane units operate in the recovery period than were in operation before the high energy cost period. Thus the number of membrane units in operation in the recovery period is greater than N and the flux is unusually low. Aeration intensity is preferably not reduced during the recovery period, and so the recovery period may reduce a decrease in service life caused by the method 100.

Steps 120, 150 and 210 are also optional, and intended to reduce a decrease in service life that may be caused by use of the method 100. Many water treatment plants 10 have an equalization tank located upstream of the process tanks and membrane tanks. The equalization tank receives raw feed at a rate that varies throughout the day but allows this feed to be transferred to the process tanks at a generally constant rate. In other water treatment plants 10, the process tanks or the process tanks and membrane tanks function as equalization tanks. To summarize steps 120, 150 and 210, the equalization capacity of the water treatment plant is used to allow the required plant permeate flow to be reduced during a high energy cost period. Reducing the required plant permeate flow allows a proportional decrease in flux in the operating membrane units, thus reducing the flux increase resulting from shutting down one or more membrane units. In step 120, an equalization tank may be drained down in anticipation of a high energy cost period by operating at above a seasonal average transfer rate and correspondingly high plant permeate flow. In step 150, the transfer rate from the equalization rate is reduced to below the seasonal average rate during a high energy cost period, allowing a corresponding reduction in plant permeate flow. In step 210, the transfer rate is restored to the seasonal average rate. If the process tanks, or process tanks and membrane tanks, function as equalization tanks then corresponding changes to the plant permeate flow rate may be made without also changing feed transfer rates.

An alternative process may be used in a plant that is already operating with an automated control process, for example a control process based on membrane resistances such as a process a described in US Publication No. 2007/0039888 which is incorporated herein by this reference to it. In such a process, one or more real time membrane resistance values are calculated using operational parameters such as flux, TMP and water temperature using resistance in series methods. The results, for example a change in after backwash resistance or cake resistance, are compared with corresponding set points and decisions are made in how to modify system operational parameters. The operational parameters may be modified on a step wise manner, one at a time, following a hierarchy of control changes. If a resistance value is larger than a pre-set high limit, steps are taken to reduce fouling. For example, any non-operating trains are put on line and, if further changes are required, aeration is increased. If the value of every measured resistance is equal or less than a pre-set low limit, steps are taken to reduce energy consumption, for example aeration may be decreased and, if a further changes is possible, a train is shut down.

During a high cost period, the computing device 14 detects modifies a set point, or otherwise make a change in the automated process likely to cause reduced energy consumption. For example, in the automated control strategy described above, one or both of the high and low resistance limits are increased. Optionally, increases in aeration may also be temporarily prohibited and the shut down of at least one train may be mandated, or both. Even with the automated process continuing to operate otherwise unchanged, energy usage is likely to decrease.

Under a complex time of use program, one or two highest energy cost periods in a day may be only 2 to 6 hours in total duration, and the cost differential between these highest cost periods and the lowest cost energy period may be a factor of two or more. Although a train may be shut down for a longer part of a day, shutting down a train during only one or two highest energy cost periods having a total daily duration of 8 hours or less, or 6 hours or less, may provide most of the energy cost savings with less reduction in service life. Under a critical peak period program, all rates may be doubled or tripled again during a very short period of time, for example the afternoons of 5 or 10 days out of a year. In that case, a significant energy cost savings may be achieved by optionally shutting down a train only during the critical peak periods. This would have very little effect on the service life of the membranes, and any decrease in service life might be recovered by operation at unusually low flux during low energy cost periods.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A process for operating an immersed membrane filtration system comprising the steps of,
a) detecting the time of an actual or potential high energy cost period; and,
b) shutting down one or more membrane units during some or all of the detected high energy cost period.

2. The process of claim 1 further comprising a step of increasing the flux of one or more membrane units that remain in operation during the high energy cost period.

3. The process of claim 2 wherein the flux of the one or more membrane units that remain in operation is increased toward, but not above, a selected maximum flux.

4. The process of claim 3 wherein the selected maximum flux is a pre-determined maximum flux.

5. The process of claim 3 wherein the selected maximum flux is determined in view of at least one parameter applicable to the high energy cost period, the parameter selected from the set of: water temperature, water viscosity, season, outdoor air temperature, predicted outdoor air temperature, or existing aeration regime.

6. The process of claim 3 comprising a step of determining the largest number of separately controllable membrane units that can be shut down without exceeding the selected maximum flux with the one or more membrane units that remain in operation.

7. The process of claim 1 wherein the high energy cost period arises according to an electricity pricing program in which the price of electricity varies over time.

8. The process of claim 7 wherein the electricity pricing program includes one or more of time of use pricing, critical peak pricing and a critical peak rebate program.

9. The process of claim 1 wherein step a) further comprises a step of receiving a declaration, request or demand from an electricity provider.

10. The process of claim 1 further comprising a step of re-starting the one or more shut down membrane units after the high energy cost period.

11. The process of claim 1 further comprising a step of starting up one or more additional membrane units before or after the high energy cost period.

12. The process of claim 1 further comprising steps of increasing a plant permeate rate before the high energy cost period and decreasing a plant permeate rate during the high energy cost period.

13. The process of claim 3 wherein an aeration regime applied to the one or more membrane units that remain in operation remains generally constant when the flux of the one or more membrane units that remain in operation is increased toward the selected maximum flux.

14. An immersed membrane filtration system comprising,
a) a plurality of separately controllable membrane units;
b) process controllers adapted to operate the plurality of separately controllable membrane units; and,
c) a computing device adapted to instruct the process controllers,
wherein the computing device is programmed to detect the presence of high energy cost period and to shut down one or more of the plurality of membrane units during some or all of the high energy cost period.

15. The system of claim 14 wherein the computing device has access to or incorporates stored data representing a pre-determined time of use electricity pricing system.

16. The system of claim 14 wherein the computing device is connected to an operator interface or communications device adapted to advise the computing device of a pricing period declared by an electricity provider.

17. The system of claim 14 wherein the computing device is connected to a communications device allowing an electricity provided to send a request or demand for reduced energy consumption to the computing device.

18. The system of claim 14 wherein the computing device is connected to one or more sensors and is adapted to calculate a maximum flux applicable for some or all of the high energy cost period considering one or more signals from the one or more sensors.

19. The system of claim 14 wherein the computing device is configured to increase one or more resistance set points during a high energy cost period.

20. The system of claim 14 wherein the computing device is configured to receive an input related to outdoor air temperature or a prediction of outdoor air temperature and to consider the input in detecting the presence of a high energy cost period.
